(19) United States
(12) Patent Application Publication
(10) Pub. No.: US 2012/0166547 A1
(43) Pub. Date: Jun. 28, 2012

(54) SYSTEMS AND METHODS FOR RECORDING AND DISTRIBUTING MEDIA

(76) Inventor: Michael A. Sharp, Porter, TX (US)

(21) Appl. No.: 13/174,361

(22) Filed: Jun. 30, 2011

Related U.S. Application Data
(60) Provisional application No. 61/427,094, filed on Dec. 23, 2010.

(51) Int. Cl. G06F 15/16

(52) U.S. Cl. 709/205

(57) ABSTRACT

The system includes providing a recorded version of a popular song for download to a plurality of users. One or more of the plurality of users are allowed to download the popular song, record their own voice to the popular song, and save the new version of the modified popular song. The modified popular song is received and providing for download to the plurality of users.

### CROSS-REFERENCE TO RELATED APPLICATION

This application claims the benefit of U.S. Provisional Application No. 61/427,094, filed Dec. 23, 2010, which is incorporated herein by reference in its entirety.

### FIELD

The present disclosure is directed to methods and systems for recording and distributing media.

### BACKGROUND

Various services exist for downloading music over a network, such as the Internet. However, such services do not provide the user with the ability to create and distribute their own music in the manner described herein.

### SUMMARY

The following description includes various systems and methods for recording and distributing media. In one embodiment, the systems and methods disclosed herein allow anyone with an iPad™, iPhone™, or other similar device to create new master recordings of popular songs with their own voice singing along with pre-recorded music accompaniment.

Additionally, in some embodiments, the invention facilitates a distribution capability that allows the singer to potentially monetize their song versions and earn revenue (e.g., up to 20%) of each download sale of their versions of popular songs. The methods and systems herein also provide a method for accounting for all sales and payments due to singers and publishers.

In one embodiment, a method of recording and distributing media is provided. The method includes providing a recorded version of a popular song for download to a plurality of users. One or more of the plurality of users are allowed to download the popular song, record their own voice to the popular song, and save the new version of the modified popular song. The modified popular song is received and the modified version of the popular song is provided for download to the plurality of users.

In some embodiments, the method of recording and distributing media comprises running a software app on an iPad™ or iPhone™. In other embodiments, a plurality of users can be registered by receiving biographical information about the users and that information can be made available for download along with the modified version of the popular song.

The foregoing and other objects, features, and advantages of the invention will become more apparent from the following detailed description, which proceeds with reference to the accompanying figures.

### BRIEF DESCRIPTION OF THE DRAWINGS

FIG. 1 is a screenshot of a user interface of a method for recording and distributing media using an iPad™.

FIG. 2 is a screenshot of a user interface of a method for recording and distributing media using an iPhone™.

FIG. 3 is a screenshot of a user interface of a method for recording and distributing media using an iPad™.

FIG. 4 is a screenshot of a user interface of a method for recording and distributing media using an iPhone™.

FIG. 5 is a schematic illustration of information being exchanged from a user device to a server.

FIG. 6 is a schematic illustration of information being exchanged from a user device to a server.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

Implementations of Methods and Systems Using Software

The systems and methods described herein may be implemented or performed by software stored on one or more tangible computer-readable media (e.g., one or more optical media discs, volatile memory or storage components (such as DRAM or SRAM), or nonvolatile memory or storage components (such as hard drives)) and executed on one or more computing systems. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods.

### Overview

“Song Apps” are native iPhone/iPad™ (or other similar device) applications that are based on single song titles such as those as featured on Sing Top 10's YouTube™ channel. With these apps, users can create recorded “mixes” that can either be listened to from within the application or uploaded and sold as download in the iTunes™ store. When uploading their song mixes, users enter biographical and personal data, as well as their recording. The content provided through these can be controlled through the SongApp™ YouTube™ playlist.

Additionally, in some embodiments, the systems and methods disclosed herein provide a distribution capability that allows the singer to potentially monetize their song versions and earn revenue (up to 20%) of each download sale of their versions of popular songs (after Apple's 30% handling fee and the 9.1 cent statutory royalty paid to the publisher).

Using the systems and methods disclosed herein, popular songs can be recreated by studio musicians and made available for purchase in the iTunes™ store as apps featuring a built in rehearsal/recording distribution feature. Thus the app provides not only the song, but also a built in rehearsal and recording studio. Each song is typically hosted on cloud hosting services such as YouTube™ and streamed to the app on demand by the singer

Singers can find the SongApp™ versions in iTunes™ for purchase of $1.49, and each selection include a large library of current chart topping hits. Once a singer has selected and purchased the SongApp™, the app is downloaded to their mobile device (e.g., iPad™, iPhone™).

The app is very simple to use, offering singers options that include the ability to rehearse and record their voice singing along with the prerecorded music. After the singer is satisfied with the rehearsal results s/he may select the recording option. As the song plays back, the singer's voice along with the prerecorded music is recorded. At any time the singer can stop the recording and save for review. When the user is satisfied with the recording, the user has the option to save the recording to the iPhone™, iPad™, or other device. More than one take can be saved for instant review and selections can be saved or deleted at will.

If the recorded song is satisfactory to the singer, the option for distribution in the iTunes™ or other online store is made available. If the distribution option is selected and the EULA agreement within the SongApp™ is checked the recording can then be uploaded along with the singer's bio and contact information to the SongApp™ server.

In some embodiments, the bio and contact information can be collected and an accounting channel is created in the singer's name. A distribution fee such as $9.99 would be paid by the singer and is collected at the point of upload submission this transaction handled by the iTunes™ or app store. Each song can be reviewed for quality control. Once the song is reviewed it can be then listed in iTunes™ or similar app store such as Android™ for distribution and potential sales.

In some embodiments, the system can provide accounting software that keeps track of all sales made by the singer for their versions and pays the publisher for each download as well as the artist/singer for every sale made in the iTunes™ store.

In some embodiments, payments can be limited until certain amounts are reached. For example, a threshold of $100.00 dollars can be set before a singer receives payment in a calendar quarter. Once a singer has reached the threshold, a flag can be sent to the accountant with the singers contact information for payment disbursement. Payments can be made within 45 days after a singer has reached the minimum threshold. Additionally, singers may have an option to review weekly sales trends for an additional fee in the apps accounting section. This fee can be collected by iTunes™ in the iTunes™ store built in to the app.

### User Interface

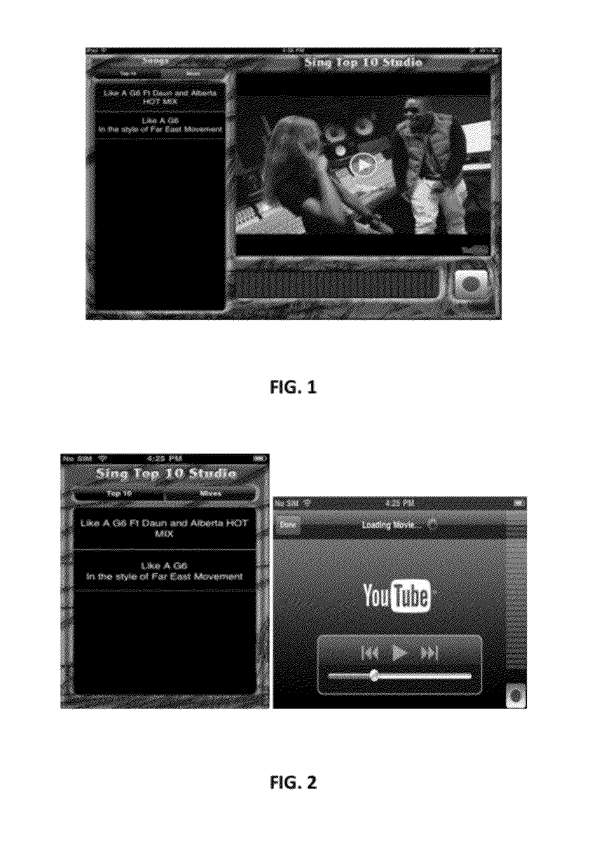

The user interface (UI) for STTS consists of two modal lists: Songs and Mixes. While viewing the Songs list, the user sees the current list of recordings for the purchased SongApp™ from the YouTube™ playlist, a visual karaoke-style video pane, and a user-controlled recording mechanism and sound meter. As shown in FIG. 1, this UI can be presented in one screen for the iPad™ and, as shown in FIG. 2, two screens for the iPhone™ or other mobile device.

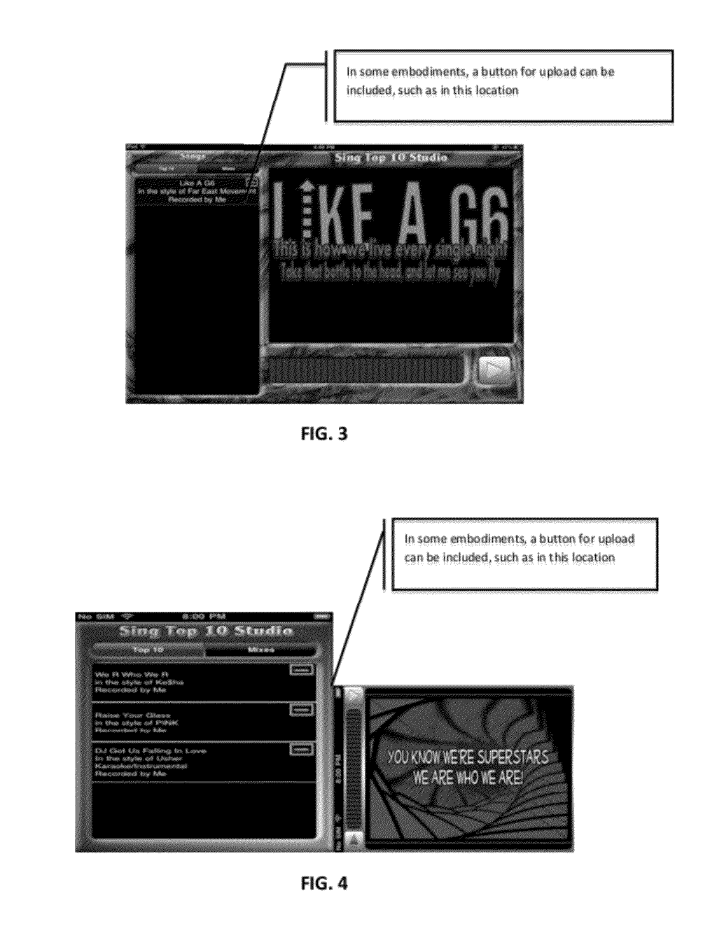

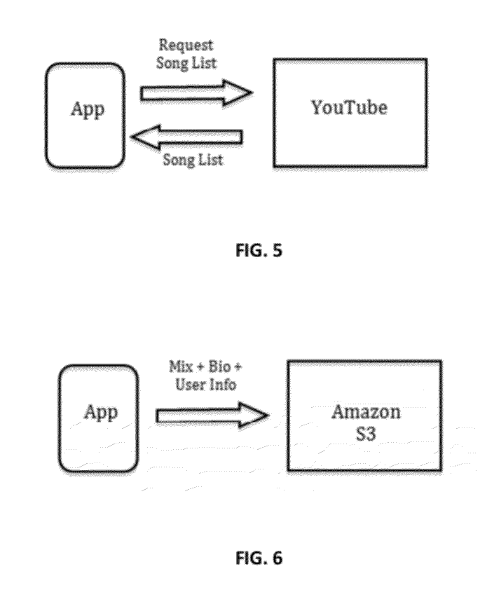

FIGS. 3 and 4 illustrate exemplary views of a first Mixes list. FIG. 3 illustrates a UI with Mixes for the iPad™ and FIG. 4 illustrates a UI with Mixes for an iPhone™ or other smaller-screened mobile device. The Mixes list view presents the user with their recorded song tracks, along with a playback button, eject button (iPhone™ only), and sound meter. Each song in the Mixes list can have a delete (−) button and an upload (↑) button.

### Operational Description

When the user launches the “SongApp™” application on their iPad™, iPhone™, or other similar device, a splash screen is presented while the application pulls down the YouTube™ playlist, using YouTube's authorized application program interface (API) protocol. FIG. 4 illustrates a schematic view of the operation and transfer of information between the user's device (e.g., iPad™, iPhone™, etc.) and a content server (e.g., a YouTube™ server).

When the user the taps on a song in the Song list, the YouTube™ video is presented. The user then has the option to tap the play button to listen to the song, as well as tap a record button to record their voice with the song as it is played through the iPad™/iPhone™ stereo speakers. At any time the user can stop the recording, upon which their recording is added to the Mixes list, and their screen is changed to the Mixes list view.

Tapping on songs in the Mixes list presents a thumbnail view from the YouTube™ video, along with a play button. Tapping the play button allows the user to listen to the song and their own voice. Upon tapping the eject button (iPhone™ only), the playback view is dismissed and the Mixes list is presented. Each song in the Mixes list has a delete button (−) so that users can delete their recordings and start over again.

Additionally, each song can have an upload (↑) button. Upon tapping that button, users are presented with a screen to enter their bio and user information. Once they complete this form, they are presented with the alert informing them of the cost to upload and distribute their song mix (“distribution fee”), with the option to accept or cancel. Upon accepting, the application immediately charges the distribution fee to their iTunes™ accounts using Apple's In-App purchase protocol.

Once the user enters all necessary information and successfully completes the distribution fee transaction, their information and their song mix is uploaded to a secure repository hosted by Amazon™. FIG. 6 illustrates a schematic of the exchange of information between the user's device and a server (e.g., Amazon's server).

Once this information and song mix is uploaded, it is parsed and validated, then uploaded for sale on Apple's iTunes Store. This can be either manual or automated. Once a user's song is successfully for sale on the iTunes Store, they receive an email informing them that their SongApp™ mix is for sale along with an iTunes™ link to their song.

The following steps illustrate one embodiment for recording and distributing media. In the first step, a popular song can be recreated with studio musicians, either with or without a melody line. Then, the recreated song can be uploaded to YouTube™ or another server where the song can be available with and/or without the melody line in a YouTube™ list. In another step, SongApp™ can pull the songlist from YouTube™ and includes a recording and distribution option. SongApp™ can be uploaded to iTunes™ for sale in the AppStore for $1.49. A singer can purchase the SongApp™ from iTunes™ etc. The singer can rehearse with the song in the SongApp™ rehearsal studio. The singer can record and save one or more takes using the SongApp™. The singer can select a song from the mixes saved, and select upload (for distribution option) in SongApp™. Then, the singer can complete distribution form, sign EULA, and pay by credit card the distribution fee to upload the song to the SongApp™ server. The song can be reviewed for quality control and sent to iTunes™ for sale under the singer's name. The SongApp™ can be automated to account for sales. Once the song has reached a threshold of $100.00 during any calendar quarter, a flag alert can be sent to the accountant for royalty distribution to the singer. Additionally, each song download sale can be tracked by the accounting software and at the end of 45 days, the publisher can be sent his royalty check if the amount exceeds any prepaid amount for that song title.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A method of recording and distributing media, the method comprising:
providing a recorded version of a popular song for download to a plurality of users;
allowing one or more of the plurality of users to download the popular song, record their own voice to the popular song, and save the new version of the modified popular song;
receiving the modified popular song; and
providing the modified version of the popular song for download to the plurality of users.

2. The method of claim 1, wherein the method of recording and distributing media comprises running a software app on an iPad or iPhone.

3. The method of claim 1, further comprising:
registering a plurality of users by receiving biographical information about the users; and
making that information available for download along with the modified version of the popular song.

4. A computer-readable storage medium storing computer-executable instructions for causing a computer to perform a method, the method comprising:
providing a recorded version of a popular song for download to a plurality of users;
allowing one or more of the plurality of users to download the popular song, record their own voice to the popular song, and save the new version of the modified popular song;
receiving the modified popular song; and
providing the modified version of the popular song for download to the plurality of users.
